(19) United States
(12) Patent Application Publication
(10) Pub. No.: US 2010/0315603 A1
(43) Pub. Date: Dec. 16, 2010

(54) ELEVATOR SHAFT PROJECTION SYSTEM

(76) Inventor: Shie-Chang Jeng, Tainan City (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/482,845

(22) Filed: Jun. 11, 2009

(51) Int. Cl. G03B 21/28

(52) U.S. Cl. 353/82

(57) ABSTRACT

A projection system configured in an elevator shaft is designed to project a same image at a same time on elevator shaft doors of different stories with a single projector. Each of the shaft doors functions as a projection screen, persons in the lobby before the elevator shaft door can watch the image or images displayed on the shaft door during the time waiting for the elevator car.

### FIELD OF THE INVENTION

This invention relates to a projection system, especially relates to a projection system configured in an elevator shaft and a same image or images shall be projected on each of the shaft door screens.

### BACKGROUND

FIG. 1 is a prior art which shows a well known elevator system in a building. An elevator shaft 19 communicates with different stories through shaft doors 111, 112, 113 for each of the first floor F1, second floor F2, and third floor F3 . . . etc., of the building. An elevator car 10 moves up and down in the shaft 19. The traditional shaft doors 111, 112, and 113 do not have any additional function except for open/close for customers to board/unboard the elevator car 10. It shall be quite good if the shaft doors can be a projection screen for commercials.

### BRIEF DESCRIPTION OF THE DRAWINGS

FIG. 1 is a Prior Art

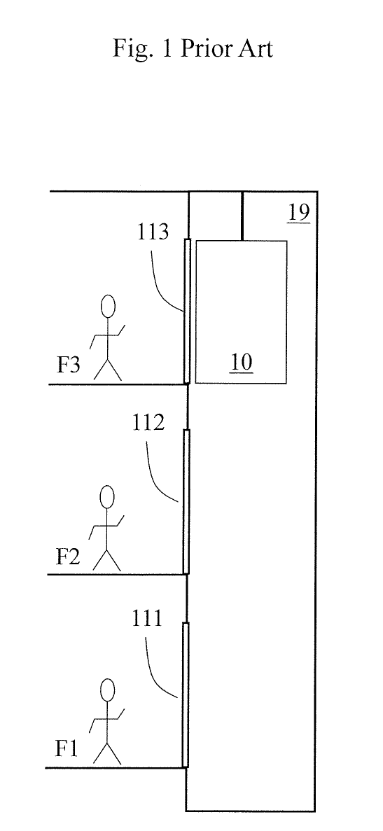

FIG. 2 is a first embodiment according to the present invention.

FIG. 3 is a second embodiment according to the present invention.

FIG. 4 is a third embodiment according to the present invention.

FIG. 5 is a top view for FIG. 3 according to the present invention.

FIG. 6 is another top view for FIG. 3 according to the present invention.

FIG. 7 is a modification to FIG. 6 according to the present invention.

FIG. 8 is a modification to FIG. 4 according to the present invention.

FIG. 9 is a top view for FIG. 8 according to the present invention.

FIG. 10 is a three dimensional view for FIG. 5 according to the present invention.

FIG. 11 is a modification to FIG. 10 according to the present invention.

### DETAILED DESCRIPTION OF EMBODIMENTS

The applicant firstly proposes a projection system configured in an elevator shaft to project commercials or other images onto the shaft doors for people to watch while waiting in the floor lobby outside each of the elevator shaft doors. With this invention, a same image or images can be displayed at a same time on each shaft door screen for different stories with single projector.

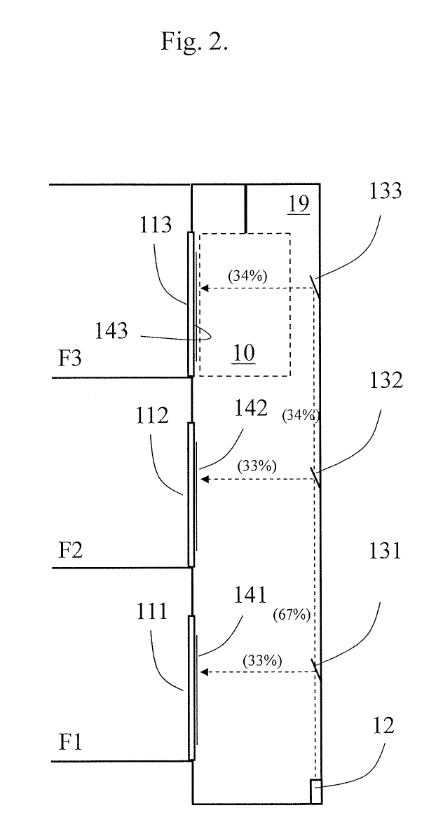

FIG. 2 is a first embodiment according to the present invention. A projector 12 is configured on the bottom of a shaft 19 where an elevator car 10 moves up and down. Each of the shaft doors 111, 112, 113 is made transparent and a sheet of screen material 141, 142, 143 is pasted on a surface of each of the shaft doors 111, 112, 113 facing the shaft 19 to make the shaft doors suitable as a projection screen.

Each piece of transflective films or beam splitters 131, 132, 133 is mounted on the wall of the shaft 19 in a position suitable for reflecting an image onto the screen material 141, 142, 143. The projector 12 projects an image upward to each of the transflective films 131, 132, 133. Each of the transflective films or beam splitters 131, 132, 133 is made partially reflective and partially penetrable for the image projected from the projector 12. As an example in FIG. 2, the transflective film or beam splitters 131 is made 33% reflective and 67% penetrable; the transflective film 132 is made 33% reflective and rest 34% penetrable; and the transflective film 133 is made fully reflective for reflection the remaining 34% of the image. In this case, each of the shaft doors 111, 112, 113 receives almost the same light strength of the same image which is projected by the projector 12.

For another example, in case of a building which has five stories, a transflective film for first floor is made 20% reflective and remaining 80% penetrable; a transflective film for second floor is made another 20% reflective and remaining 60%; a transflective film for third floor is made another 20% reflective and remaining 40%; a transflective film for fourth floor is made another 20% reflective and remaining 20%; a transflective film for fifth floor is made another 20% reflective. Each of the floor display the same image with a same image beams strength at the same time theoretically without calculating optical losses of the image beams strength.

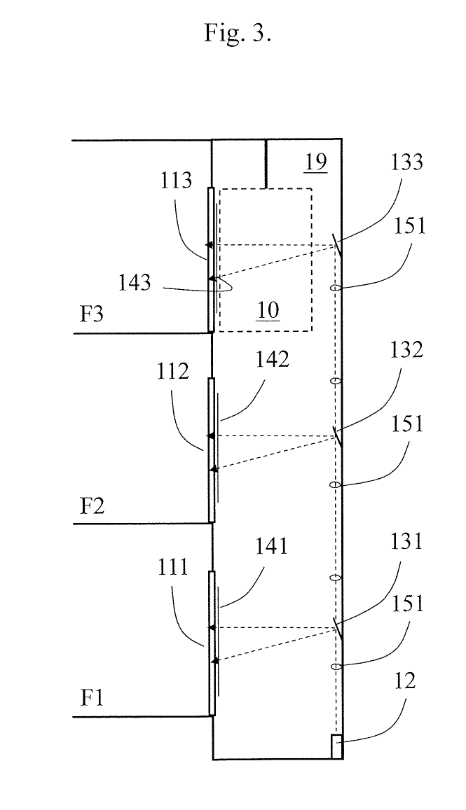

FIG. 3 is a second embodiment according to the present invention. Each of a first lens or lens set 15 1 depends, is configured before each of the transflective films 131, 132, 133 for modifying the image including but not limited to diverge, converge, or focus the image before the image reaches each of the transflective films 131, 132, 133.

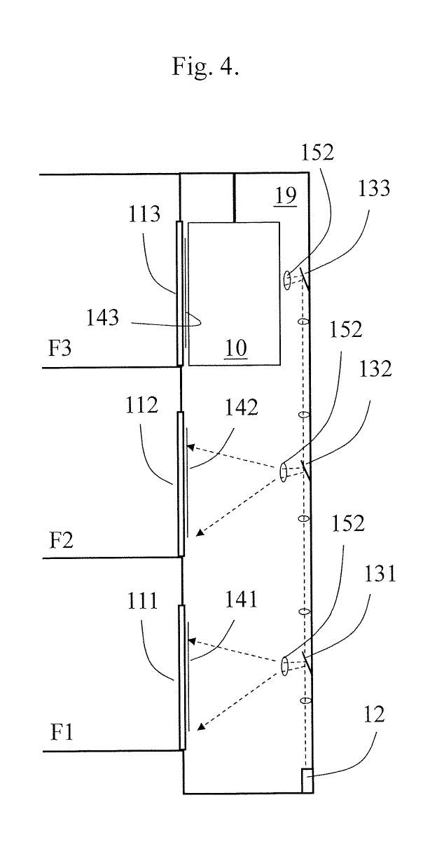

FIG. 4 is a third embodiment according to the present invention. Each of a second lens or lens set 152 depends, is configured before each of the screen materials 141, 142, 143 for modifying the image including but not limited to diverge, converge or focus the image before the image reaches each of the screen materials 141, 142, 143.

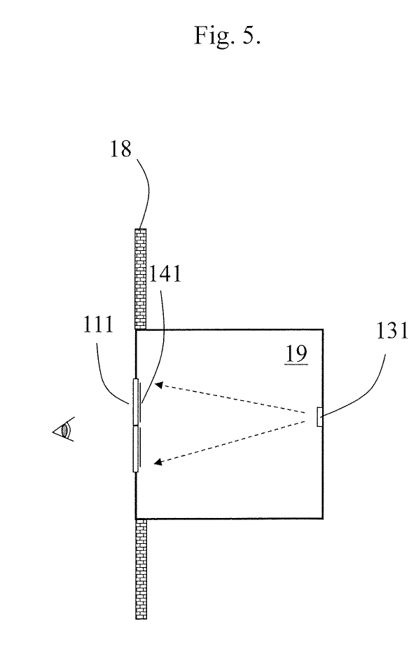

FIG. 5 is a top view for FIG. 3 according to the present invention. Two sheet of screen material 141 are pasted on a surface of each of the shaft door 111 facing the shaft 19. Meanwhile, the shaft door 111 is made transparent so that person waiting outside the elevator shaft door 111 can watch an image or images displayed on the screen material 141. The screen material 141 pasted on the surface facing the shaft 19 is only for example, it can be chosen to paste on an opposite surface of the shaft door 111.

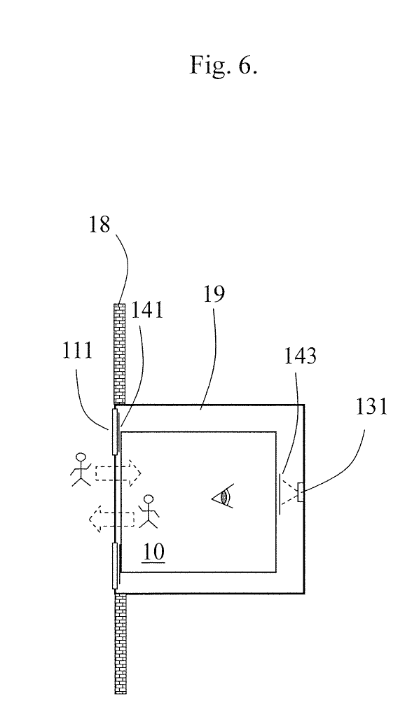

FIG. 6 is another top view for FIG. 3 according to the present invention. While the elevator car 10 reaches the floor, the shaft door 111 opens and the elevator car door (not shown in the figure) opens, the image can no more be displayed on the screen material 111. At this moment, a screen material 143 is pasted on a transparent wall of the car 10 for displaying the image which can be viewed from inside the car 10. Additional control unit (not shown) can be added to adjust the focus of the lens or lens sets.

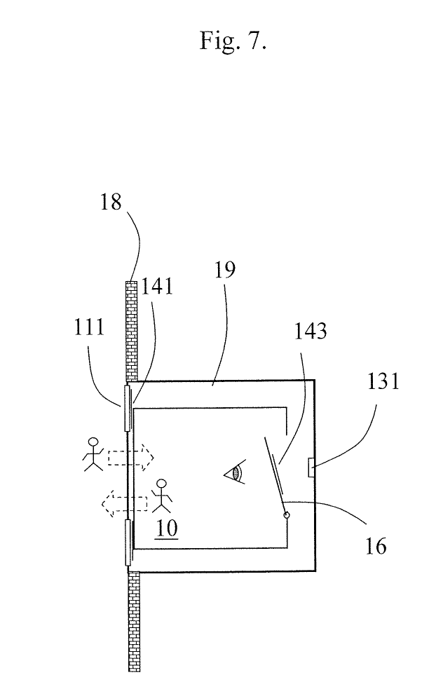

FIG. 7 is a modification to FIG. 6. A window or door 16 which can be open/closed is made on the wall of the elevator car 10 in a position suitable to maintain either the screen material 143 or the transflective film 131 or other physical components for the projection system.

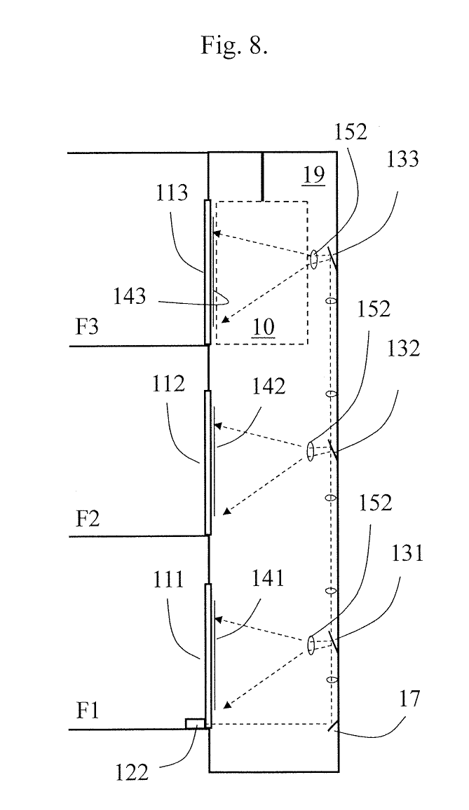

FIG. 8 is a modification to FIG. 4. A projector 122 can be mounted on the floor of the lobby F1 instead of mounted inside the shaft 19 for facilitating maintenance to the projector.

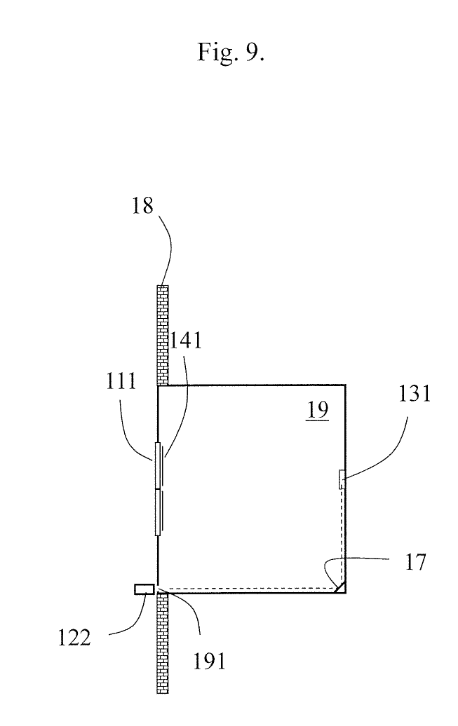

FIG. 9 is a top view for FIG. 8. Additional reflective mirror 17 may be required for adjusting the light path from the projector 122 which is configured outside the shaft 19 to a suitable direction for projection.

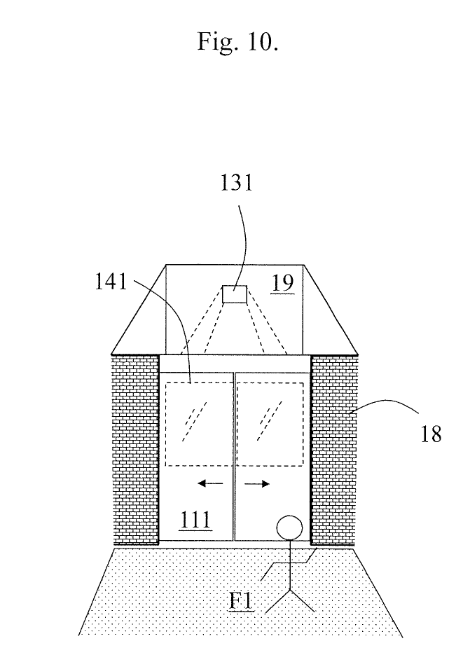

FIG. 10 is a three dimensional view for FIG. 5. While the shaft door 111 is closed. People waiting on the lobby of, for example, F1 can watch the image or images displayed on the screen material 141. The transflective film 19 reflects the image onto the screen material 141 which is pasted on a surface of the shaft door 111.

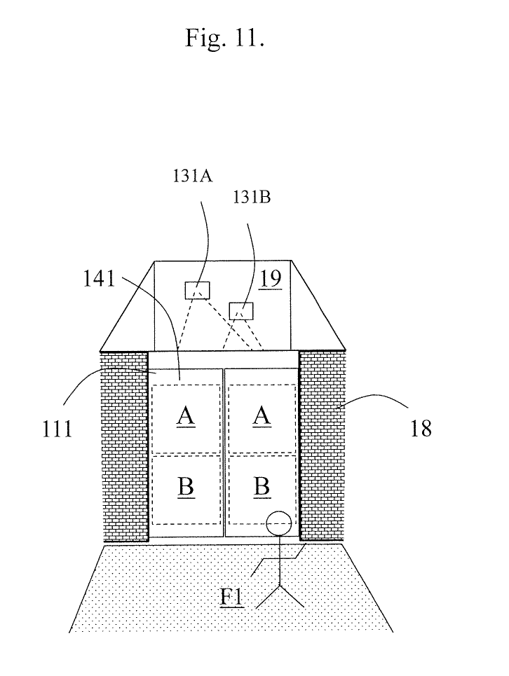

FIG. 11 is a modification to FIG. 10 according to the present invention. A second projection system (not shown) like the one described for FIG. 2, FIG. 3 or FIG. 4 can be added in the shaft 19 for projecting a second image or images. The second projection system includes at least a second projector (not shown) and a second transflective films each for one of the floors. As can be seen in FIG. 10, a first image A on top of the shaft door 111 is projected from the transflective film 131A of a first set of projection system, and a second image B on bottom of the shaft door 111 is projected from the transflective film 131B of a second set of projection system.

While several embodiments have been described by way of example, it will be apparent to those skilled in the art that various modifications may be made without departing from the spirit of the present invention. Such modifications are all within the scope of the present invention, as defined by the appended claims. The shaft door is a projection screen.

What is claimed is:

1. An elevator shaft projection system, comprising:
a projector, providing a first image;
a first shaft door screen;
a second shaft door screen, in a position above said first shaft door screen;
a first transflective film, reflecting partial of said first image onto said first shaft door screen; penetrating remaining portion of said first image; and
a second transflective film, reflecting partial or all of said penetrated image from said first transflective film onto said second shaft door screen.

2. An elevator shaft projection system as claimed in claim 1, further comprising a first lens or lens set, for modifying said first image before said first image reaching to said transflective film.

3. An elevator shaft projection system as claimed in claim 1, further comprising a second lens or lens set, for modifying said image before said image reaching to said shaft door screen.

4. An elevator shaft projection system as claimed in claim 1, wherein said shaft door screen comprising:
a transparent shaft door; and
a first screen sheet, configured on a surface of said transparent shaft door.

5. An elevator shaft projection system as claimed in claim 4, wherein said surface is facing said shaft.

6. An elevator shaft projection system as claimed in claim 4, wherein said surface being opposite to a surface facing said shaft.

7. An elevator shaft projection system as claimed in claim 1, comprising:
a car, moving up and down in said shaft;
a second screen sheet, configured on a wall of said car near said transflective film, for
accepting and displaying an image from said transflective film when the car stop on each floor.

8. An elevator shaft projection system as claimed in claim 7, further comprising a control unit to adjusting focus of said second lens or lens set.

9. An elevator shaft projection system as claimed in claim 7, comprising:
a maintenance door, made on the wall of the car; for maintaining either said screen sheet or said transflective film.

10. An elevator shaft projection system as claimed in claim 1, wherein said projector is located in said shaft.

11. An elevator shaft projection system as claimed in claim 9, wherein said projector is located outside the shaft.

12. An elevator shaft projection system as claimed in claim 9, further comprising a reflective mirror for adjusting direction of said image projected from said projector.

13. An elevator shaft projection system as claimed in claim 1, wherein said transflective film is replaced with a beam splitter.

14. An elevator shaft projection system as claimed in claim 1, further comprising:
a second projector for projecting second image;
a third transflective film, reflecting partial of said second image onto said first shaft door screen; penetrating remaining portion of said second image; and
a fourth transflective film, reflecting partial or all of said penetrated second image from said third transflective film onto said second shaft door screen.
